(19) United States
(12) Patent Application Publication
(10) Pub. No.: US 2002/0069148 A1
(43) Pub. Date: Jun. 6, 2002

(54) Electronic negotiation and fulfillment for package of financial products and/or services

(76) Inventors: Steve C. Mutschler, Vienna, VA (US); Sandra L. Devine, Arlington, VA (US)

Correspondence Address: STAAS & HALSEY LLP, 700 11TH STREET, NW, SUITE 500, WASHINGTON, DC, 20001, US

(21) Appl. No.: 09/729,090

(22) Filed: Dec. 5, 2000

(51) Int. Cl. G06F 17/60

(52) U.S. Cl. 705/35

(57) ABSTRACT

An apparatus and process for (a) electronically negotiating in real time between a first party and a second party to attain a negotiated agreement for a package of financial accounts to meet financial needs of the first party; and (b) automatically fulfilling the negotiated agreement by electronically closing accounts of the first party which relate to the package and which preexist at a financial institution not providing accounts as part of the package, and electronically delivering the closed accounts to a financial institution which is providing accounts as part of the package.

### CROSS-REFERENCE TO RELATED APPLICATIONS

This application is related to U.S. application titled DECISION MANAGEMENT SYSTEM FOR CREATING STRATEGIES TO CONTROL MOVEMENT OF CLIENTS ACROSS CATEGORIES, U.S. Ser. No. 09/217,017, filed Dec. 21, 1998, and which is incorporated herein by reference.

This application is related to U.S. application titled SIMULTANEOUS CUSTOMER/ACCOUNT STRATEGY EXECUTION IN A DECISION MANAGEMENT SYSTEM, U.S. Ser. No. 09/216,985, filed Dec. 21, 1998, and which is incorporated herein by reference.

This application is related to U.S. application titled USE OF ONLINE ANALYTICAL PROCESSING (OLAP) IN A RULES BASED DECISION MANAGEMENT SYSTEM, U.S. Ser. No. 09/217,016, filed Dec. 21, 1998, and which is incorporated herein by reference.

This application is related to U.S. application titled VERSIONING IN A RULES BASED DECISION MANAGEMENT SYSTEM, U.S. Ser. No. 09/219,341, filed Dec. 23, 1998, and which is incorporated herein by reference.

This application is related to U.S. application titled PARAMETER HIERARCHY FOR A DECISION MANAGEMENT SYSTEM, U.S. Ser. No. 09/219,340, filed Dec. 23, 1998, and which is incorporated herein by reference.

This application is related to U.S. application titled DECISION MANAGEMENT SYSTEM WHICH IS CROSS-FUNCTION, CROSS-INDUSTRY AND CROSS-PLATFORM, U.S. Ser. No. 09/219,338, filed Dec. 23, 1998, and which is incorporated herein by reference.

This application is related to U.S. application titled DECISION MANAGEMENT SYSTEM PROVIDING QUALITATIVE ACCOUNT/CUSTOMER ASSESSMENT VIA POINT IN TIME SIMULATION, U.S. Ser. No. 09/258,348, filed Feb. 26, 1999, and which is incorporated herein by reference.

### BACKGROUND OF THE INVENTION

1. Field of the Invention

The present invention is directed to an apparatus and method for electronically negotiating a package of financial accounts between a customer and a financial institution, and for automatically and electronically fulfilling the negotiated package.

2. Description of the Related Art

Account holders (i.e., customers) of financial institutions often desire to move an account from one financial institution to another. For example, an account holder may desire to move a checking account from one bank to another bank, or move a stock trading account from one brokerage company to another brokerage company.

FIG. 1 is a diagram illustrating a conventional system for transferring accounts from one financial institution to another, that is, from a delivering financial institution (DFI) 10 to a receiving financial institution (RFI) 12. A transfer of an account from DFI 10 to RFI 12 typically occurs after RFI 12 sends marketing information to a potential customer to entice that potential customer to transfer accounts to RFI 12. Hereafter, the terms “potential customer” and “customer” may be used interchangeably.

Referring now to FIG. 1, an RFI Master Customer Information File (MCIF) 20 passes information via a communication channel 22 to a customer 24. The passed information describes an offering made to customer 24, and might include, for example, a bank account offering, a credit card offering and/or a brokerage account offering. The offering is often mass-distributed, i.e., it is offered to all customers and is not customized for different customers. Communication channel 22 might be, for example, the Internet, a telephone operator, a branch representative, a radio or television commercial, or a print advertisement.

Depending on the available communication channels and the nature of the communication, customer 24 could respond to the offering in many different ways, such as by direct mail or via online communication through the Internet. In the case of direct mailings or online communication through the Internet, an application generally must be printed and returned by customer 24 to RFI 12 for approval.

Typically, customer 24 will contact a customer service representative (CSR) 26 of RFI 12, in accordance with instructions provided in the offering. Customer 24 will typically provide additional personal and financial information to CSR 26 to supplement the application. CSR 26 may then contact a third party information provider 28 for additional information to further supplement the application. For example, third party information provider 28 might be a credit bureau providing a credit report for customer 24. Communications between CSR 26 and third party information provider 28 might occur through the mail, or in real-time.

The information provided by customer 24 and third party information provider 28 is fed into the RFI's customer databases (DB) 30. Another customer service representative (CSR)32 of RFI 12 then manually approves or denies the application. Once the application is approved or denied, customer 24 is typically notified either by telephone or via direct mail, as indicated by element 34 in FIG. 1.

If the application is approved, a new account is created by CSR 32 and stored in the RFI's account database (DB) 36. If appropriate, CSR 32 then forwards a credit settlement by check to DFI 10. Typically, CSR 32 forwards an account closing notification to DFI 10 through a DFI customer service representative (CSR) 40.

In the most advanced financial institutions, CSR 32 may forward the new account creation to a workflow system 42, which will send notification to DFI CSR 40 via EDI or direct mail, and will set up the new account.

Once DFI CSR 40 receives the notification to close the account, the closing of the account will be manually approved or denied, and appropriate information will be forwarded to the DFI's customer and account database (DB) 44. If the request is approved, DFI CSR 40 will, if appropriate, send a draft check to RFI 12.

The capability exists, although it is not general practice, for DFI 10 to send payment to RFI 12 using Electronic Funds Transfer (EFT) via the automated clearinghouse (ACH). In this case, funds are received by RFI 12 within 30 days, and deposited at RFI 12. Customer 24 will be sent notification of account closure by DFI 10.

In FIG. 1, all elements which are a part of RFI 12 are shown as being inside the dotted enclosure defining RFI 12. Similarly, all elements which are a part of DFI 10 are shown as being inside the enclosure defining DFI 10. Therefore, it should be understood that RFI 12 and DFI 10 are very separate entities which rely on conventional, relatively inefficient communication channels such as the telephone and direct mail to correspond with each other. Moreover, much of the processing between RFI 12 and DFI 10 to transfer accounts is typically done manually by human representatives communicating through the mail. Electronic communication and processing such as EDI, EFT or ACH is only used for those specific tasks for which these electronic communication and processing systems are designed.

FIG. 2 is a diagram illustrating the conventional transfer of securities from a DFI to an RFI, and is in conformance with regulations for the securities industry. Here, it is assumed that a customer has existing securities at the DFI.

Referring now to FIG. 2, in step 60, the customer (or potential customer) reviews information about account offerings by the RFI, and is enticed by the information. Therefore, the customer choose a new account to be opened at the RFI.

From step 60, the process moves to step 62, where the customer completes and signs a Transfer Initiation Form (TIF) at the RFI.

From step 62, the process moves to step 64, where the completed TIF is transmitted via ACATS (a known transfer system) to the National Securities Clearing Corporation (NSCC) where a control number is assigned to the account.

From step 64, the process moves to step 66, where data (customer name, account type, social security number, account number at the DFI, RFI's NSCC participant number, DFI's participants number, etc.) is sent to the DFI. The DFI must then send either a list of assets in the account to the NSCC, or reject the request within three days. Once assets are submitted to the NSCC, they are reported to the RFI, verified by DFI, and a two day review process is incurred during which the DFI may adjust the list of assets or the RFI may reject the account.

From step 66, the process moves to step 68, where, on the sixth day, the NSCC determines how the assets will settle. Most stocks and bonds are netted with the RFI and DFI settling trades through NSCC's Continuous Net Settlement (CNS) system. The Depository Trust Corporation (DTC) receives instructions to transfer the securities between the brokers using its book-entry system. ACATS generates instructions for receiving and delivering T-notes or T-bonds, mortgage-backed securities and other non DTC/CNS eligible securities. Some types of securities must be physically delivered, and the instructions are issued to the participants the day prior to settlement of assets.

From step 68, the process moves to step 70, where the actual transfer of the securities is performed.

The overall process in FIG. 2 is relatively quick because the securities industry is regulated to require most publically traded US stock and securities account transfers to occur within six days. However, transfer of accounts in other industries can take much longer.

For example, FIG. 3 is a diagram illustrating the transfer of an account between financial institutions, such as banks, in the banking industry. Referring now to FIG. 3, in step 72, a customer reviews bank offerings presented to the customer typically via advertisements, literature or telephone contact. The offerings are limited to standardized bank offerings which are not customized to meet the customers'preferences.

From step 72, the process moves to step 74, where, after a review of the offerings, the customer chooses the bank as a new RFI and/or, if appropriate, chooses a new account type.

From step 74, the process moves to step 76, where the customer completes/signs an application. A customer must complete a new account application for each specific bank account type to open the account, though a single application may in some cases be used to open both a savings and draft checking account. Applications can currently be completed at a bank branch, or by telephone or by the Internet. Transaction processing may take several days while the bank manually verifies information and opens the account.

In step 76, the customer also signs a Transfer Authorization Form for an account at a DFI. Transfers currently require a physical signature. There exists the ability to transfer multiple accounts from one bank to the new RFI using one Transfer Authorization Form, but a separate Transfer Authorization Form is required for each bank from which accounts or funds are being transferred. The signed Transfer Authorization Form generally requires ABA routing, or a transit number, which may make it more difficult for transfers to occur from banks to brokerages.

From step 76, the process moves to step 78, where the customer initiates closure of the old account at the DFI. However, the Transfer Authorization Form signed in step 76 can designate the RFI to initiate the closure of the old account. At this time, notification of closure is sent to the DFI via direct mail, or the customer can physically go to the DFI and directly cancel the old account.

From step 78, the process moves to step 80, where, if appropriate, a draft check is sent, typically by mail, from the DFI to the RFI. Alternatively, the customer can close the account at the DFI and pay for a bank check. The customer would then provide the bank check to the RFI in person or via mail.

From step 80, the process moves to step 82, where, if the overall process in FIG. 3 was to open a new checking or savings account, the RFI would deposit the received money in the new checking account/savings account.

Opening a money market, certificate of deposit (CD), bond or other account is not a simple transfer from one financial institution to another, and requires additional new account applications to be completed and processed. Typically, as indicated in step 82 of FIG. 3, a money market, CD or other account may be opened by first opening either a savings or checking account, transferring money into that account, then debiting the checking/savings account and crediting the money to open a money market, CD or other account.

The overall process in FIG. 3 is protracted, as transfers are processed using draft checks, not electronic transfer mechanisms such as ACH. The total time for a bank to close an account, issue a draft check, send it via direct mail, and for the customer to receive the draft check may be two to three weeks or longer.

As can be seen from FIGS. 1-3, the process of transferring accounts from a DFI to an RFI can be a complex, difficult, time consuming process, which typically includes a lot of human intervention and interaction. Moreover, different types of securities, and different types of financial institutions, require different processes to transfer accounts, thereby injecting more complexity into the situation.

As a result, it currently may take up to three months to transfer a financial account from a DFI to an RFI, depending on the type of account being transferred. Moreover, it is often the responsibility of the customer to ensure that the documentation is transferred, and for non-securities accounts that the transfer is completed properly. This slow, inefficient process is costly and cumbersome both to the customer and to the financial institutions participating in the transfers.

Moreover, if a customer desires to transfer an entire package of different accounts at different DFIs to a single RFI, such a transfer would be extremely complex, difficult and time consuming for the customer. For example, the customer would typically have to individually transfer each account in a specific manner based on the type of DFI, the type of RFI and the type of account being transferred. In such a situation, the customer would often choose to simply leave preexisting accounts open, but dormant, at the DFIs instead of transferring these accounts to the RFI.

Further, as can be seen from the above, customers are typically presented with standard financial offerings which are not customized to the specific customer needs.

### SUMMARY OF THE INVENTION

Accordingly, it is an object of the present invention to provide an account transfer apparatus and method which allows a customer to electronically negotiate in real-time with a financial institution for a package of financial accounts, and, upon completion of the negotiation, which automatically fulfills the negotiated package by automatically and electronically transferring to the financial institution all preexisting accounts related to the package and currently at other financial institutions.

Additional objects and advantages of the invention will be set forth in part in the description which follows, and, in part, will be obvious from the description, or may be learned by practice of the invention.

The foregoing objects of the present invention are achieved by providing an apparatus and method which (a) electronically negotiates in real time between a first party and a second party to attain a negotiated agreement for a package of financial accounts to meet financial needs of the first party; and (b) automatically fulfils the negotiated agreement by electronically closing an account of the first party which relates to the package and which preexists at a financial institution not providing accounts as part of the package, and electronically delivering the closed account to a financial institution which is providing accounts as part of the package.

Objects of the present invention are also achieved by providing an apparatus and method which (a) presents information by a first party to a second party, the information indicating a financial need of the first party; (b) prepares an initial package of financial accounts by the second party to meet the financial needs of the first party; (c) presents the initial package to the first party; (d) iteratively and electronically negotiates in real time between the first and second parties, from the initial package, to attain a negotiated agreement between the first and second parties for a finalized package of financial accounts to meet the financial needs of the first party; and (e) automatically fulfils the negotiated agreement by electronically closing an account of the first party which relates to the finalized package and which preexists at a financial institution not providing accounts as part of the finalized package, and electronically delivering the closed account to a financial institution which is providing accounts as part of the finalized package.

In addition, objects of the present invention are achieved by providing an apparatus and method in which (a) an application is completed by a first party, the completed application indicating financial needs of the first party; (b) the completed application is analyzed to create an initial package of financial accounts to meet the financial needs of the first party; (c) the initial package is presented to the first party; (d) iterative and electronic negotiation takes place in real time between the first and second parties, from the initial package, to attain a negotiated agreement between the first and second parties for a finalized package of financial accounts to meet the financial needs of the first party; (e) the negotiated agreement is automatically fulfilled by electronically closing an account of the first party which relates to the finalized package and which preexists at a financial institution not providing accounts as part of the finalized package, and electronically delivering the closed account to a financial institution which is providing accounts as part of the finalized package; and (f) automatic learning is performed with data from the analyzing of the completed application, the negotiation, and the fulfilling of the negotiated agreement, to improve negotiating results for the second party in subsequent negotiations with other parties.

Further, objects of the present invention are achieved by providing an apparatus and method which includes (a) electronically accessing a web site by a first party through an electronic communications network, the web site including an application; (b) electronically completing the application on the web site by the first party, the completed application indicating financial needs of the first party; (c) automatically analyzing the completed application by a second party; (d) automatically creating an initial package of financial accounts by the second party to meet the financial needs of the first party, based on the automatically analyzed, completed application; (e) electronically presenting the initial package to the first party by the second party through the electronic communications network; (f) iteratively and electronically negotiating in real time between the first and second parties through the electronic communications network, from the initial package, to attain a negotiated agreement between the first and second parties for a finalized package of financial accounts to meet the financial needs of the first party; and (g) automatically fulfilling the negotiated agreement by electronically closing an account of the first party which relates to the finalized package and which preexists at a financial institution not providing accounts as part of the finalized package, and electronically delivering the closed account to a financial institution which is providing accounts as part of the finalized package.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 (prior art) is a diagram illustrating a system for transferring accounts from a DFI to an RFI.

FIG. 2 (prior art) is a diagram illustrating the transfer of securities from a DFI to an RFI.

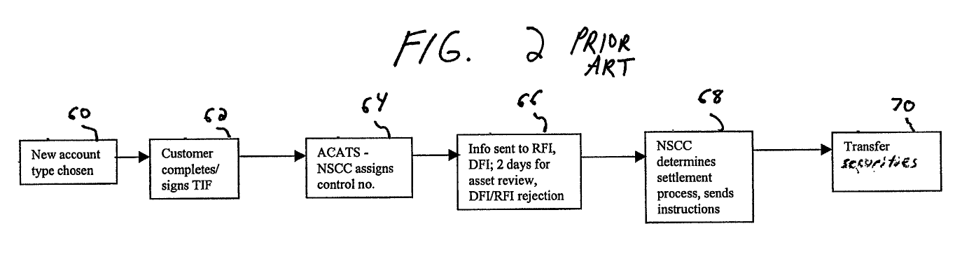

FIG. 3 (prior art) is a diagram illustrating the transfer of an account between banks.

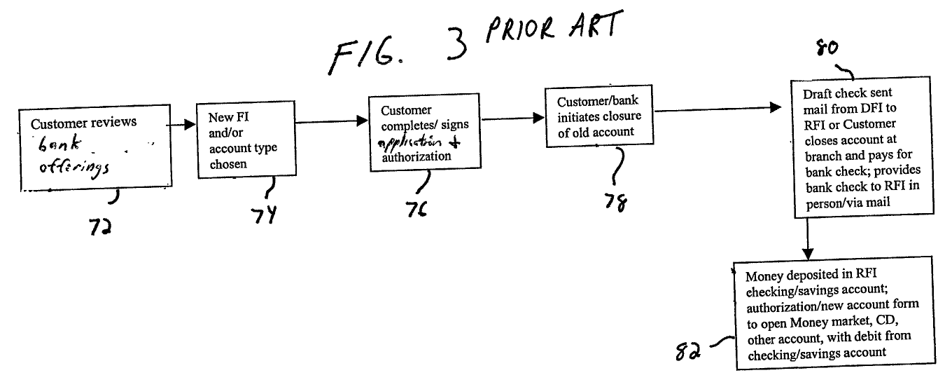

FIG. 4 is a diagram illustrating the overall architecture of a financial account transfer system, according to an embodiment of the present invention.

FIG. 5 is a diagram illustrating further details of the architecture of a financial account transfer system, according to an embodiment of the present invention.

FIG. 6 is a diagram illustrating an overview of the operation of a financial account transfer system, according to an embodiment of the present invention.

FIG. 7 is a more detailed diagram illustrating the overall operation of a financial account transfer system, according to an embodiment of the present invention.

FIG. 8 is a diagram illustrating the use of various components to target customers, according to an embodiment of the present invention.

FIG. 9 is a diagram illustrating the use of a decision engine and decision engine optimizer, according to an embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

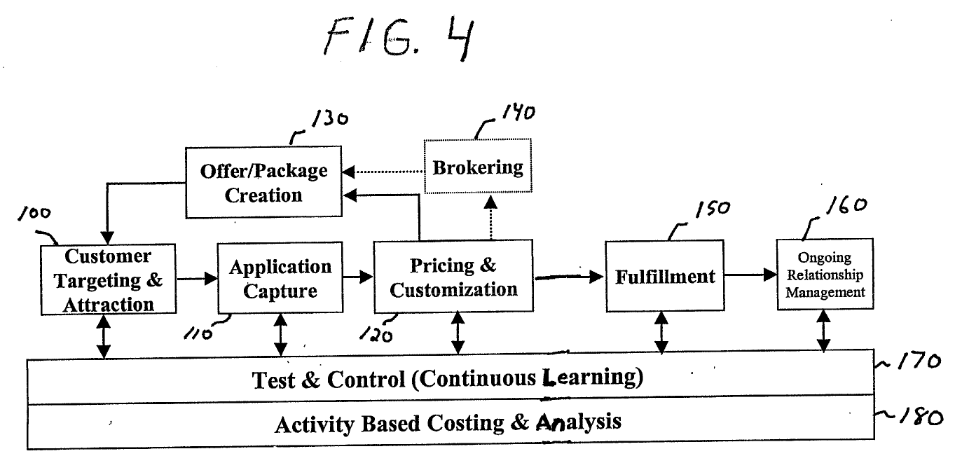

FIG. 4 is a diagram illustrating the overall architecture of a financial account transfer system, according to an embodiment of the present invention. Referring now to FIG. 4, a customer targeting & attraction component 100 allows a financial institution to target and attract desirable customers to move existing financial accounts to the financial institution from other financial institutions. Customer targeting and attraction module 100 would typically use decision engine software such as American Management Systems's STRATA decision engine, or RUBERIC's RUBERIC EMA campaign management software, to target and attract customers. Thus, customer targeting and attraction module 100 would cause some type of solicitation to be presented to the customer via, for example, direct mail, telephone contact, email, or any other type of communication channel. Alternatively, the customer might simply decide to transfer a financial account to the financial institution, independent of being solicited by the financial institution.

Typically, to effectively target and attract customers, customer targeting & attraction module 100 would employ known response modeling, referral analysis, trend analysis, customer transfer techniques and statistics.

A customer would typically be provided with different communication channels for responding to the solicitation. For example, a customer might be able to respond by accessing a web site of the financial institution, sending email or direct mail to the financial institution, or telephoning the financial institution.

An application capture module 110 allows the customer to fill out an application which would typically detail some personal information and preferences for financial accounts.

A pricing and customization module 120 takes the information in the application, and typically supplements it with additional information from external sources, such as, for example, a credit bureau. Pricing and customization module 120 then automatically customizes and prices a package of financial accounts in real-time via software processing to meet the needs of the customer as indicated by the information in the application. Thus, pricing and customization module 120 preferably customizes and prices the package to meet both the customer preferences and financial institution needs. Account variables which might typically be considered by pricing & customization module 120 might include, for example, interest rates, fees, time and other restrictions, flexibility, and account types.

Pricing & customization module 120 would typically employ known techniques for package optimization, relationship pricing optimization, elasticity analysis, and product evolution.

Pricing & customization module 120 would typically employ a software-implemented decision engine, such as, for example, American Management Systems'STRATA, to automatically perform pricing and customization in real-time.

Offer/package creation module 130 receives pricing and customization information from pricing and customization module 120, and automatically creates an offer in real-time. The offer includes, for example an offer for a type of account or package (i.e., a bundle) of accounts, and presents the offer to the customer in real time via a web site, email, telephone or other communication channel.

The customer may accept the offer, reject the offer, or make a counter offer. The customer and the financial institution can then negotiate in real-time, typically electronically, to reach a negotiated agreement for an account or a package of accounts.

A brokering module 140 could be used as an option to broker offers between the customer and other financial institutions in real-time. Thus, brokering module 140 would be involved with pricing and customization at various other financial institutions and brokering the purchase and transfer of the customer relationship. Brokering module 140 would employ known techniques for brokering analysis.

Once the customer and the financial institution agree to a relationship, a fulfillment module 150 manages a workflow process required for the new account or package. Thus, fulfillment module 150 would open the new account(s) at the receiving financial institution, transfer funds and paperwork, and close out the existing account(s) at the delivering financial institution.

Fulfillment module 150 would typically employ known techniques for cost and workflow optimization, work order and process statistics, productivity and failure (to achieve a sale) analysis.

An ongoing relationship management module 160 maintains, and typically grows, the relationship with the customer. Typically, ongoing relationship management module 160 would include known techniques for improving customer retention, cross-selling and up-selling, and other optimization strategies.

A test & control module 170 is a continuous-learning loop enabled by a decision engine and preferably with decision engine optimization software. For example, test & control module 170 would typically employ, for example, American Management Systems' STRATA decision engine. Test & control module 170 enables test-and-learn strategy creation and optimization of processes to attract and convert potential customers, increase profitability and manage costs. Typically, test & control module 170 would employ known techniques for response modeling, referral analysis, trend analysis, customer transfer rationale and statistics. Test & control module 170 would typically be used by an acquisition and account transfer system to identify the most effective offer from test and control strategies, and allow the creation of hybrid strategies that are more effective than any of the individual strategies.

An activity based costing & analysis module 180 gathers data from the various modules to provide cost analysis.

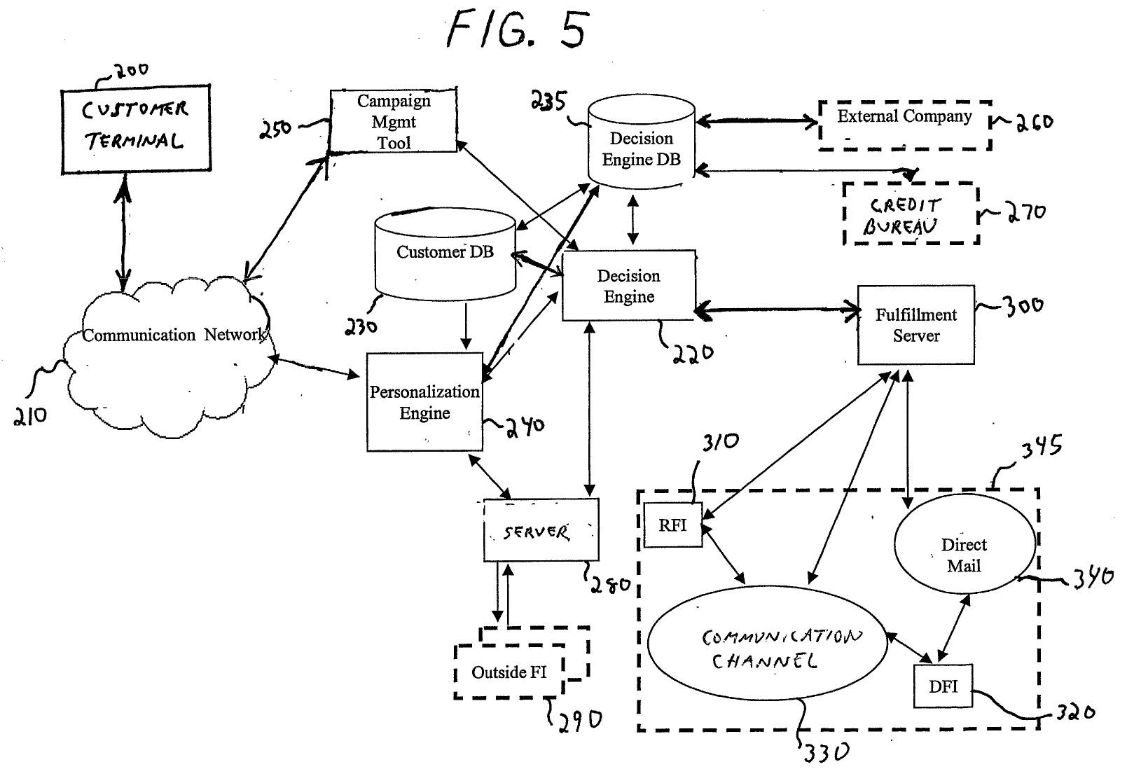

FIG. 5 is a diagram illustrating further details of the architecture of a financial account transfer system, according to an embodiment of the present invention.

Referring now to FIG. 5, a customer interacts with the system through a customer terminal 200 connected to a communications network 210. Customer terminal 200 might be, for example, a personal computer, workstation, dumb terminal, a PDA, an ATM, a PCS or other type of communicating device. Communication network 210 might be, for example, the Internet, an intranet, an extranet, a WAN, a LAN, a PCS, an automated voice response system, a wireless network or other type of communication channel. Financial institution offerings are delivered to the customer at terminal 200 through communication network 210.

The offerings are typically part of an overall marketing strategy which is developed and modified in real-time (or batch) by a decision engine 220 to deliver personalized offerings (such as financial product packages) to the customer. Decision engine 220 might be, for example, American Management Systems' STRATA decision engine. Marketing strategies and other decision logic used by decision engine 220 are typically stored in a customer database (DB) 230 and/or a decision engine database (DB) 235 which are typically maintained in-house.

A personalization engine 240 can be used to personalize the content and format of an offering as presented to the customer, and may handle some or all of the responsibilities of decision engine 220, including offer structure and pricing. Personalization engine 240 might be, for example, Broadvision's ONE-TO-ONE ENTERPRISE.

A campaign management tool 250 contains targeted marketing destinations, designed for each communication channel, and forwards these to the customer via communications network 210. The targeted marketing destinations are typically determined by decision engine 220 as part of the marketing strategy.

Decision engine database 235 would typically receive potential client lists that are purchased from an external company 260. The potential customers on this list will typically be segmented using decision engine 220, and strategies for the segments will typically be sent to campaign management tool 250 to initiate targeted marketing in an appropriate channel.

The results of an advertising campaign would typically be sent to campaign management tool 250 and to personalization engine 240. There would typically be firewalls or other security devices that exist between communication network 210 and other components in the system.

In response to an offering, the customer enters data in to the system through communication network 210. For example, through communication network 210, a customer can enter data in an application form (created, for example, using Java applets, HTML, or other format) appearing on customer terminal 200. Alternatively, customer might access a web server, such as server 280, and complete an application form on server 280. Communication network 210 would typically allow the use, for example, of click-stream data and Interactive Voice Response prompts to complete the application form.

In addition to the information entered on the application form by the customer, the system would typically be able to obtain other external information into the system through communication network 210. For example, information would typically be able to be obtained over the Internet (which may be a part of communication network 210). Such information might include, for example, customer data, account preferences, pricing options and other information.

To supplement the information entered on the application by the customer, decision engine 220 will typically obtain third party credit reports or other information from a credit bureau 270 or other third party.

The information in the application, and the various other types of obtained information, is used by decision engine 220 to produce and present an offer to the customer which meets the financial needs of the customer. Here, the offer would typically be a package of accounts customized for the specific customer. In creating the offer, decision strategies and customer profile data would typically be passed between decision engine 220, decision engine database 235 and personalization engine 240 to achieve the appropriate pricing and customization of the offer.

The customer then electronically negotiates in real-time with decision engine 220, hopefully until an agreement is reached.

If an outside financial institution 290 is allowed to participate in the relationship with the customer, decision engine 220 will typically interact with financial institution 290 through server 280, operating as a brokering server. In this case, server 280 would typically manage the negotiation process, workflow and execution of the transfer of the customer relationship to financial institution 290. When brokering is allowed, server 280, operating as a brokering server, would typically send pricing requests and related data to outside financial institutions 290,potentially through, for example, a virtual private network (VPN) or other secure mechanism.

Once the customer agrees to a financial package through real-time electronic negotiation, the negotiation is complete, and the application would typically be passed to a fulfillment server 300 for scheduling, workflow, transmission, execution and settlement. Fulfillment server 300 would typically contact both RFI 310 and DFI 320, and the appropriate assets will be transferred via electronic transfer mechanisms. When required (such as with bearer securities), assets will be transferred via paper transfer mechanisms.

For example, fulfillment server 300 would typically handle all scheduling of activities, workflow, transmission of data and funds to the appropriate institutions, execution of transfers, and settlement. For example, to accomplish these tasks, fulfillment server 300 might electronically transmit messages or funds to RFI 310. Moreover, for example, fulfillment server 300 might electronically transmits messages or funds to DFI 320 via a communication channel 330 such as electronic data interchange (EDI) using the Internet or external systems such as ACATS or ACH. Or, fulfillment server 300 might transmit messages or funds to DFI 320 via a communication channel 340 such as, for example direct mail.

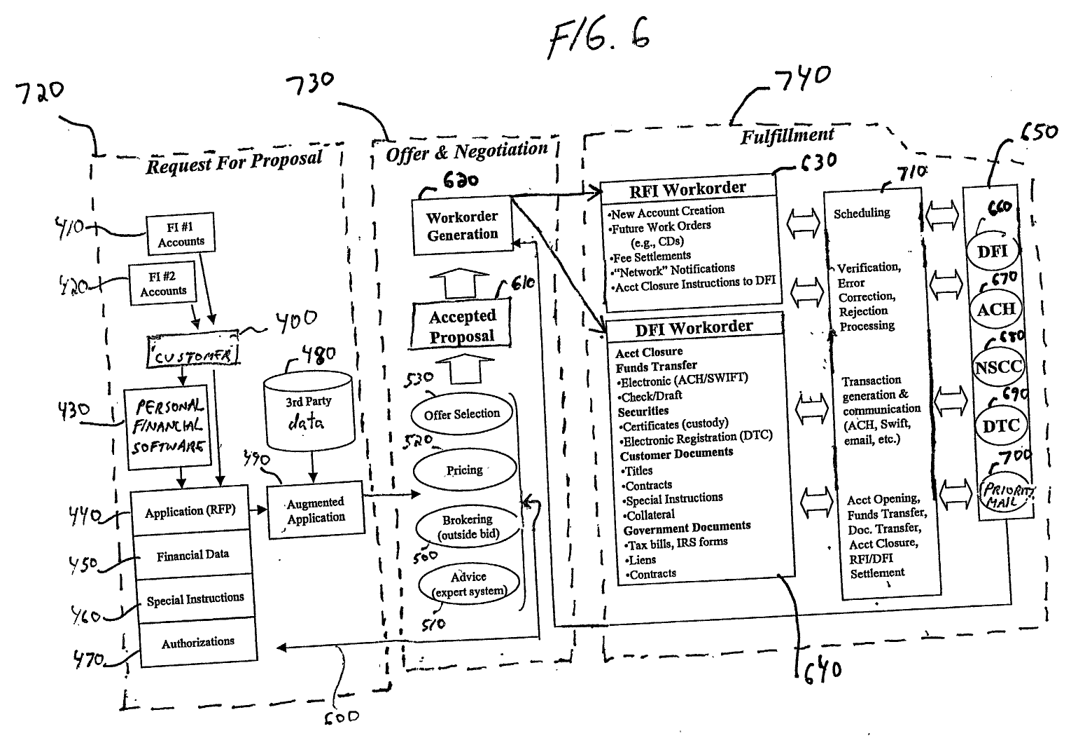

FIG. 6 is a diagram illustrating an overview of the operation of a financial account transfer system, according to an embodiment of the present invention. Referring now to FIG. 6, a prospective customer 400 has accounts 410 at financial institution (FI) #1 and accounts 420 at financial institution (FI) #2. After receiving information about other potential financial relationships, customer 400 would typically use personal financial software 430, such as INTUIT's QUICKEN or MICROSOFT's MONEY, to complete an application 440. Thus, the completed application would be considered a request for proposal (RFP) by customer 400. To complete application 440, customer 400 would typically provide financial data 450, special instructions 460 and authorizations 470. This information would typically be supplemented by third party data 480, such as that, for example, from a credit bureau, to create an augmented application 490 which would typically include a financial profile of customer 400, a listing of pre-authorized debits and credits, and existing/desired special features. Augmented application 490 is then used to create a package of financial accounts with custom pricing, to meet the needs of customer 400. Augmented application 490 might be used for possible bidding by outside financial institutions (not illustrated) if the system provides brokering capabilities 500. Augmented application 490 might also be provided to expert advice systems 510 for assistance in pricing 520 and offer selection 530 (that is, determining a proper package of financial accounts to meet the needs of customer 400).

Electronic, real-time negotiation occurs, as indicated by communication line 600, between customer 400 and the system, which hopefully culminates with an offer proposal for a package of financial accounts being accepted by customer 400, as indicated by accepted proposal 610 in FIG. 6.

After the proposal is accepted, workorder generation 620 occurs, so that a RFI workorder 630 and a DFI workorder 640 are generated. RFI workorder 630 would typically generate workorders for the RFI to create new accounts, perform future work, settle fees, send network notifications (e.g., transaction information for transfer of securities through ACATS), and to close accounts. DFI workorder 640 would typically generate workorders for the DFI to close accounts, transfer funds (either electronically, such as through ACH/SWIFT, or otherwise), transfer securities, transfer customer documents and transfer government documents. Transfers are accomplished through various transfer channels 650 including, for example, DFI 660, ACH 670, NSCC 680, DTC 690 and priority mail 700(such as, for example, FEDERAL EXPRESS).

Various activities 710 would typically occur and be monitored to ensure that RFI workorder 630 and DFI workorder 640 are properly executed through transfer 155 channels 650. Activities 710 would typically include, for example, scheduling, verification, error correction, rejection processing, transaction generation and communications (ACH, SWIFT, email, etc.), account opening, funds transfer, document transfer, account closure, RFI/DFI settlement.

Thus, the overall operation in FIG. 6 can be logically partitioned into a request for proposal section 720, an offer & negotiation section 730 and a fulfillment section 740. Generally, the processing operations performed in request for proposal section 720 and offer & negotiation section 730 would largely occur through customer interaction with customer management tool 250, decision engine 220 and personalization engine 240 in FIG. 5. Generally, the processing operations in fulfillment section 740 would largely be the responsibility of fulfillment server 300 in FIG. 5.

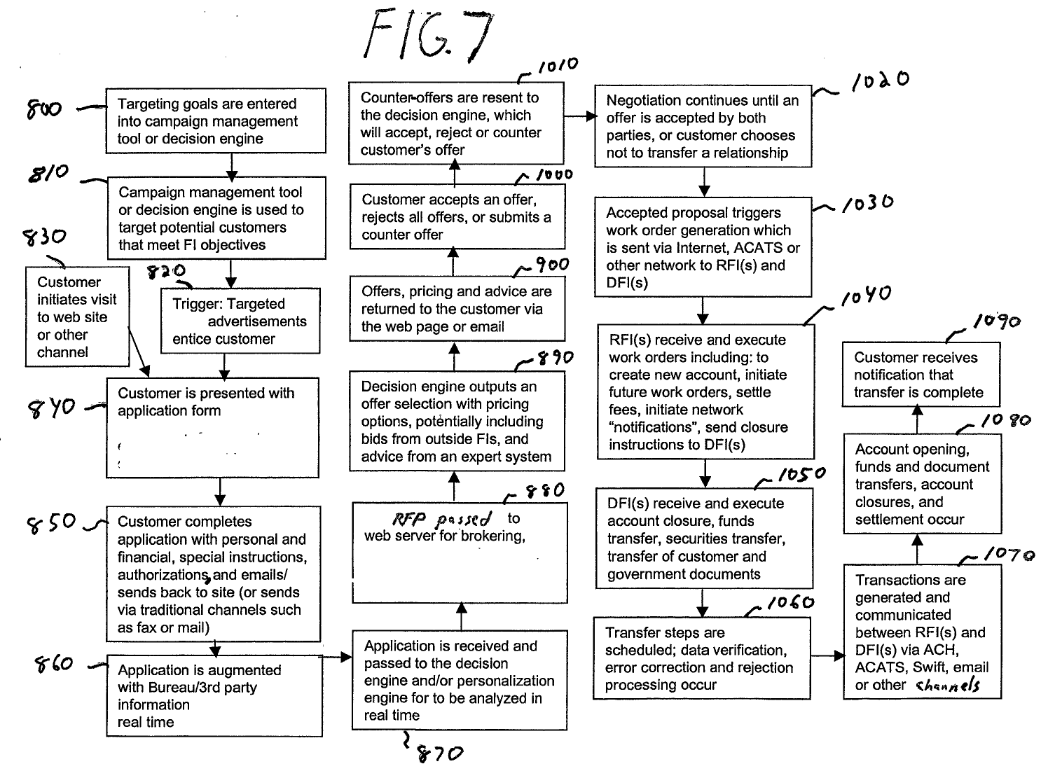

FIG. 7 is a more detailed diagram illustrating the overall operation of a financial account transfer system, according to an embodiment of the present invention. Referring now to FIG. 7, in step 800, targeting goals are entered into campaign management tool 250 or decision engine 220. From step 800, the process moves to step 810, where campaign management tool 250 and/or decision engine 220 can be used to target potential customers that meet objectives of the financial institution (FI), In targeting a potential customer, campaign management tool 250 and/or decision engine 220 would typically use customer lists generated internally, purchased from a third party, or otherwise obtained.

From step 810, the process moves to step 820, where campaign management tool 250 triggers targeted advertisements to entice potential customers. Then, as indicated in step 830, these targeted advertisements entice a customer to initiate a visit to a web site or other communication channel.

As indicated in step 840, if the customer accesses a visual communication channel, such as the Internet, ATM or PDA, the customer would typically be presented with an application form which would typically be in the form, for example, of a Java applet, HTML, XML or other format applicable for the channel.

From step 840, the process moves to step 850, where the customer completes the application with, for example, personal and financial information, special instructions and authorizations. The customer then emails/sends the completed application back to the web site. Alternatively, the customer could send the completed application back to the financial institution via traditional channels, such as fax, mail, or through a branch office, but this would remove the real-time interactivity of the system. The completed application would typically be considered a request for proposal (RFP) by the customer.

From step 850, the process moves to step 860, where the completed application is augmented in real-time with credit bureau or other third party information from a provider such as, for example, ACXIOM.

From step 860, the process moves to step 870, where the RFP (i.e., the augmented application) is received and passed to decision engine 220 or personalization engine 240, and is analyzed in real time.

From step 870, the process moves to step 880, where, if the system provides a brokering ability, decision engine 220 passes the RFP, along with relevant customer financial and personal information, to server 280 which will serve as a brokering agent to external financial institutions bidding on the customer relationship.

From step 880, the process moves to step 890, where decision engine 220 outputs an offer selection with pricing options, potentially including bids from outside financial institutions, and possibly including relevant advice from an expert system.

From step 890, the process moves to step 900, where offers, pricing and advice are returned to the customer, typically via the web site or email. Here, several different offers would typically be presented, but it is possible that only one offer is presented. Further, it is possible that no offers are presented, as the RFP might not indicate any options which are acceptable to bidding financial institutions.

From step 900, the process moves to step 1000, where the customer accepts an offer, rejects all offers, or submits a counter-offer. If the customer rejects all offers, the process would typically end.

From step 1000, the process moves to step 1010 where, if the customer issues a counter-offer, the counter-offer is resent to decision engine 220, which will decide if the counter-offer is acceptable. Thus, decision engine 220 will either accept, reject or counter the customer's offer.

From step 1010, the process moves to step 1020, where decision engine 220 continues the real-time negotiation by issuing a counter-offer or accepting the customer's latest offer. Negotiation continues until both parties accept an offer, or the customer chooses to end the negotiation and not transfer an account.

From step 1020, the process moves to step 1030, where an accepted proposal triggers fulfillment server 300 and/or a workflow system to generate work orders which will be sent via the Internet, ACATS, or other network to the applicable RFI(s) and DFI(s).

From step 1030, the process moves to step 1040, where the RFI(s) receive and execute work orders that may include, for example, creating a new account, initiating future work orders, settling fees, initiating network “notifications” (e.g., notifying ACATS of a change in stock ownership, as required by NASD), and sending closure instructions to the DFI(s).

From step 1040, the process moves to step 1050, where the DFI(s) may receive and execute work orders including account closure, funds transfer, securities transfer, other asset transfer, and transfer of customer and government documents. Steps 1040 and 1050 might typically be performed in parallel, or in reverse order from that shown.

From step 1050, the process moves to step 1060, where fulfillment server 300 schedules transfers, data is verified, data errors are corrected, and any rejection of offers by the DFI(s) or RFI(s) is processed.

From step 1060, the process moves to step 1070, where the transactions to transfer the assets are generated and communicated between the RFI(s) and DFI(s) via ACH, ACATS, Swift, email or other communication channels.

From step 1070, the process moves to step 1080, where account openings, funds and document transfers, account closures, and settlement occur.

From step 1080, the process moves to step 1090, where the customer receives notification that the transfer is complete.

As indicated above, various embodiments of the present invention include the capability to target customers. This capability is an extension of known capabilities to achieve targeted marketing.

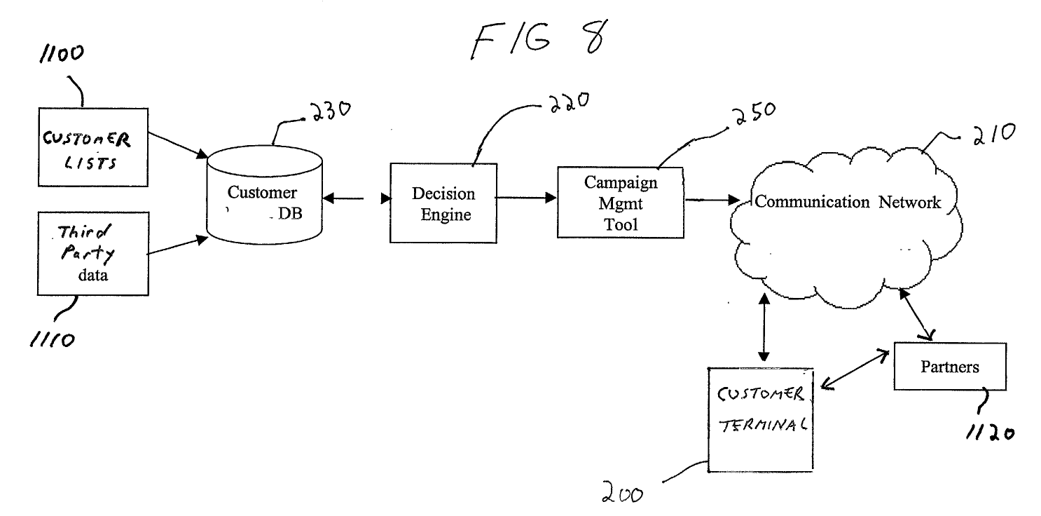

For example, FIG. 8 is a diagram illustrating the use of various components to target customers, according to an embodiment of the present invention. Referring now to FIG. 8, customer lists 1100 may be purchased from a third party, or other data 1110 may be purchased from third parties, such as, for example, a credit bureau. The lists and/or other information is typically combined and stored in customer database (DB) 230, which would typically include customer profiles. Customer database 230 feeds the profiles into decision engine 220.

Traditional decisioning would typically be used by decision engine 220 to, for example, determine customer segmentation and identify high value potential customers. Decision engine 220 would, for example, identify which customers to target for a particular campaign, and which communication channel should be used to contact the customers. These potential customers would then typically be passed to campaign management tool 250.

Campaign management tool 250 would typically format and initiate a message for the appropriate channel. The message would be transmitted through communication network 210 such as, for example, the Internet, an extranet, a WAN, a PCS, an automated voice response or other network. The messages may be transmitted directly to the potential customer through customer terminal 200, or may be passed to partners 1120 that have permission marketing agreements with their customers. In permission marketing, a company has acquired prior permission from its customers to pass on marketing information from selected partner companies.

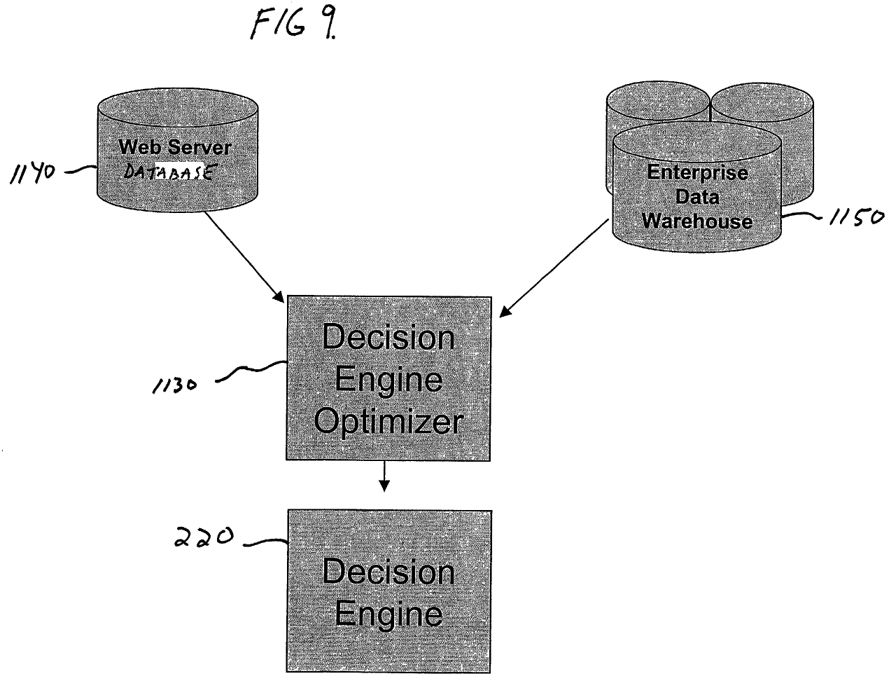

FIG. 9 is a diagram illustrating the use of a decision engine optimizer 1130 by decision engine 220 to automate the implementation of test & control module 170 (see FIG. 4), according to an embodiment of the present invention. Generally, decision engine optimizer 1130 is a software-implemented evaluation program which evaluates strategy results and adjusts the strategies based on the results. Decision engine optimizer 1130 would typically be formed using automated strategy optimization software, such as that described, for example, in various of the applications incorporated by reference herein.

Generally, alternative interaction strategies are identified and assigned a percentage of customers to test. Decision engine optimizer 1130 would typically use a variety of information sources, such as a web server database 1140 holding the results of interactions with the customer. Where the interaction takes place over mediums other than the Internet, decision engine optimizer 1130 would typically be able to access the database directly. Decision engine optimizer 1130 would also typically be able to access an enterprise data warehouse 1150.

Decision engine optimizer 1130 would typically store all contact messages, customer responses (including payments, promises to pay and other messages) in enterprise data warehouse 1150 for use in future strategy creation. Test and control group responses and success rates can then be tracked for strategy comparison. If the strategy associated with a test group is successful, that strategy may later be deployed to a larger percentage of the customers.

Thus, decision engine 220 can be used to modify the strategies and thereby improve performance through the use of alternate or hybrid strategies. Here, a hybrid strategy refers to a new strategy that will outperform either/both the test strategy or the control strategy by combining the best performing actions of each strategy. Strategies are automatically revised to create new strategies, fully automating the test-and-learn environment.

FIG. 9 shows decision engine optimizer 1130 and decision engine 220 as being separate components. However, all operations can be included in decision engine 220, and would typically be implemented as a software program running on a processor. The use of a decision engine for test and control purposes would be understood by a person of skill in the art, especially in view of the various application incorporated herein by reference.

According to the above embodiments of the present invention, a customer and a financial institution can electronically negotiate in real-time to attain a negotiated agreement for a package of financial accounts to meet financial needs of the customer. For example, as indicated in FIG. 5, the customer electronically negotiates in real time through communication network 210 with a financial institution. Such negotiation can take place electronically through email, or other electronic messaging and electronic communication techniques. Negotiation decisions on the part of the financial institution are made by decision engine 220 in real-time in accordance with strategies implemented in decision engine 220.

Further, according to the above embodiments of the present invention, an electronically negotiated agreement is automatically fulfilled. Here, the term “automatically” indicates that the fulfilment occurs by computer processing, without human intervention, upon completion of the negotiation. Thus, fulfillment does not wait for human interaction and human processing of the various fulfilment processes. Instead, accounts at a DFI are electronically closed, and the closed accounts are electronically delivered to an RFI.

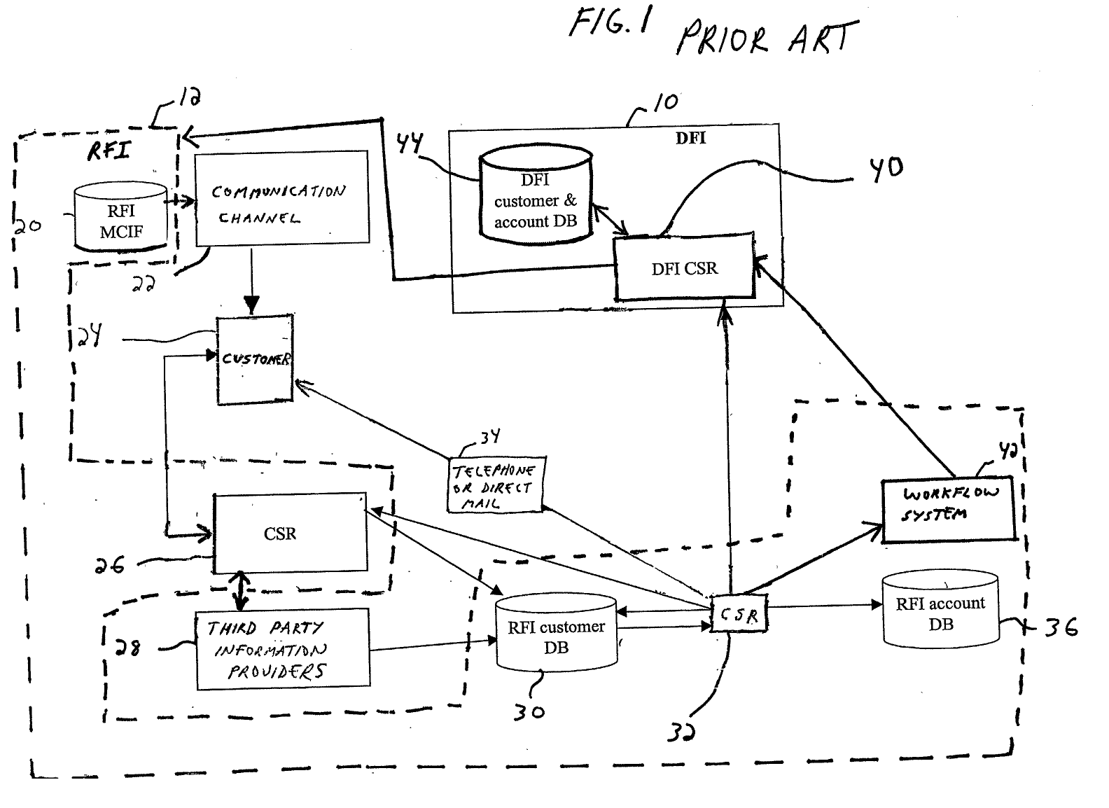

The electronic, real-time negotiation of the present invention provides significant benefits over the conventional system in FIG. 1. For example, the electronic real-time negotiation of the present invention allows a financial institution to create an offer for a package of financial accounts which is uniquely customized for the customer. As a result, there is an increased likelihood of obtaining the customer relationship and keeping the customer satisfied. This approach is significantly different than the conventional system in FIG. 1, where customers are provided with standard, non-customized, take-it-or-leave-it offers.

Moreover, the automatic fulfillment of the present invention allows accounts to easily be transferred from a DFI to an RFI, without requiring complex, time consuming manual assistance from the customer.

The above embodiments of the present invention relate to the transfer of financial accounts from one financial institution to another financial institution. Here, the term “financial institution” refers to banks, savings & loans, brokerage companies, credit card companies, loan companies, or any other types of entities providing financial accounts. Moreover, the term “financial account” refers to any type of financial product or service offered by a financial institution. For example, financial accounts can include bank accounts, savings accounts, loan accounts, credit card accounts, mutual fund accounts, and any other account which holds a financial interest or security such as, for example, certificates of deposits, money markets, stocks, bonds.

The apparatus set forth in the present application may be specifically constructed for the required purposes or it may comprise a general-purpose computer or other network devices selectively activated or reconfigured by a computer program stored in the computer. The processes presented herein are not inherently related to any particular computer or other apparatus. In particular, various general-purpose machines may be used with programs in accordance with the teachings herein, or it may prove more convenient to construct a more specialized apparatus to perform the required steps. While the present invention can certainly be realized on a so-called personal computer, including those employing the INTEL PENTIUM architecture, any data processing device capable of performing the required operation may be used, including computers ranging from hand-held devices to mainframes. Where used herein, means-plus-function language, in accordance with 35 USC 112(6), typically encompasses a central processing unit (CPU) with associated software causing it to perform the described functions in conjunction with the CPUs associated hardware.

With respect to the software described herein, one of ordinary skill in the art will recognize that there exits a variety of platforms and languages for creating software for performing the processes outlined herein. One of ordinary skill in the art also recognizes that the choice of the exact platform and language is often dictated by the specifics of the actual system constructed, such that what may work for one type of general purpose computer may not be efficient on another type of general purpose computer.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A process comprising:
electronically negotiating in real time between a first party and a second party to attain a negotiated agreement for a package of financial accounts to meet financial needs of the first party; and
automatically fulfilling the negotiated agreement by electronically closing an account of the first party which relates to the package and which preexists at a financial institution not providing accounts as part of the package, and electronically delivering the closed account to a financial institution which is providing accounts as part of the package.

2. A process as in claim 1, wherein the second party is a broker for a financial institution providing accounts as part of the package.

3. A process as in claim 1, wherein the second party is a financial institution providing accounts as part of the package.

4. A process as in claim 1, wherein the second party is a financial institution, and is the only financial institution providing accounts as part of the package.

5. A process as in claim 1, further comprising, before performing said electronically negotiating:
electronically presenting information by the first party to the second party indicating the financial needs of the first party.

6. A process as in claim 5, wherein
said electronically presenting comprises electronically completing an application accessible through an electronic communications network by the first party, the completed application indicating the financial needs of the first party,
the process further comprises automatically analyzing the completed application to automatically create an initial package of financial accounts by the second party, and
said electronically negotiating comprises iterative back and forth electronic negotiating between the first and second parties, from the initial package, to attain the negotiated agreement.

7. A process as in claim 1, wherein said automatically fulfilling closes a plurality of accounts of the first party which relate to the package and which preexist at financial institutions not providing accounts as part of the package, and electronically delivers the closed accounts to at least one financial institution which is providing accounts as part of the package.

8. A process as in claim 1, further comprising:
performing automatic learning with data from said electronically negotiating and said automatically fulfilling to improve negotiating results for the second party in subsequent negotiations with other parties.

9. A process as in claim 1, wherein said automatically fulfilling automatically fulfils the negotiated agreement by electronically closing all accounts of the first party which relate to the package and which preexist at a financial institution not providing accounts as part of the package, and electronically delivers the closed accounts to a financial institution which is providing accounts as part of the package.

10. A process comprising:
presenting information by a first party to a second party, the information indicating a financial need of the first party;
preparing an initial package of financial accounts by a second party to meet the financial needs of the first party;
presenting the initial package to the first party;
iteratively and electronically negotiating in real time between the first and second parties, from the initial package, to attain a negotiated agreement between the first and second parties for a finalized package of financial accounts to meet the financial needs of the first party; and
automatically fulfilling the negotiated agreement by electronically closing an account of the first party which relates to the finalized package and which preexists at a financial institution not providing accounts as part of the finalized package, and electronically delivering the closed account to a financial institution which is providing accounts as part of the finalized package.

11. A process as in claim 10, wherein the second party is a broker for a financial institution providing accounts as part of the finalized package.

12. A process as in claim 10, wherein the second party is a financial institution providing accounts as part of the finalized package.

13. A process as in claim 10, wherein
said presenting information comprises completing an application by the first party, the completed application indicating the financial needs of the first party, and
said preparing an initial package comprises analyzing the completed application to create the initial package to meet the needs of the first party.

14. A process as in claim 10, wherein
said presenting information comprises electronically completing an application by the first party and which is accessible by the first party through an electronic communications network, the completed application indicating the financial needs of the first party, and
said preparing an initial package comprises automatically analyzing the completed application, and automatically creating the initial package from the analyzed, completed application.

15. A process as in claim 10, further comprising:
performing automatic learning with data from said iteratively and electronically negotiating and said automatically fulfilling to improve negotiating results for the second party in subsequent negotiations with other parties.

16. A process as in claim 10, further comprising:
performing automatic learning with data from said preparing an initial package, said iteratively and electronically negotiating, and said automatically fulfilling, to improve negotiating results for the second party in subsequent negotiations with other parties.

17. A process as in claim 10, wherein said automatically fulfilling closes a plurality of accounts of the first party which relate to the finalized package and which preexist at financial institutions not providing accounts as part of the finalized package, and electronically delivers the closed accounts to at least one financial institution which is providing accounts as part of the finalized package.

18. A process comprising:
completing an application by a first party, the completed application indicating financial needs of the first party;
analyzing the completed application to create an initial package of financial accounts to meet the financial needs of the first party;
presenting the initial package to the first party;
iteratively and electronically negotiating in real time between the first and second parties, from the initial package, to attain a negotiated agreement between the first and second parties for a finalized package of financial accounts to meet the financial needs of the first party;
automatically fulfilling the negotiated agreement by electronically closing an account of the first party which relates to the finalized package and which preexists at a financial institution not providing accounts as part of the finalized package, and electronically delivering the closed account to a financial institution which is providing accounts as part of the finalized package; and
performing automatic learning with data from said analyzing the completed application, said iteratively and electronically negotiating, and said automatically fulfilling, to improve negotiating results for the second party in subsequent negotiations with other parties.

19. A process as in claim 18, wherein the application resides on a web site, and said completing an application is electronically performed by the first party on the web site.

20. A process as in claim 18, wherein said automatically fulfilling closes a plurality of accounts of the first party which relate to the finalized package and which preexist at financial institutions not providing accounts as part of the finalized package, and electronically delivers the closed accounts to at least one financial institution which is providing accounts as part of the finalized package.

21. A process comprising:
electronically accessing a web site by a first party through an electronic communications network, the web site including an application;
electronically completing the application on the web site by the first party, the completed application indicating financial needs of the first party;
automatically analyzing the completed application by a second party;
automatically creating an initial package of financial accounts by the second party to meet the financial needs of the first party, based on the automatically analyzed, completed application;
electronically presenting the initial package to the first party by the second party through the electronic communications network;
iteratively and electronically negotiating in real time between the first and second parties through the electronic communications network, from the initial package, to attain a negotiated agreement between the first and second parties for a finalized package of financial accounts to meet the financial needs of the first party; and
automatically fulfilling the negotiated agreement by electronically closing an account of the first party which relates to the finalized package and which preexists at a financial institution not providing accounts as part of the finalized package, and electronically delivering the closed account to a financial institution which is providing accounts as part of the finalized package.

22. A process as in claim 21, further comprising:
performing automatic learning with data from said automatically analyzing the completed application, said iteratively and electronically negotiating, and said automatically fulfilling, to improve negotiating results for the second party in subsequent negotiations with other parties.

23. A process as in claim 21, wherein said automatically fulfilling closes a plurality of accounts of the first party which relate to the finalized package and which preexist at financial institutions not providing accounts as part of the finalized package, and electronically delivers the closed accounts to at least one financial institution which is providing accounts as part of the finalized package.

24. An apparatus comprising:
a computer system allowing electronic negotiation in real time between a first party and a second party to attain a negotiated agreement for a package of financial accounts to meet financial needs of the first party; and
a electronic system automatically fulfilling the negotiated agreement by electronically closing an account of the first party which relates to the package and which preexists at a financial institution not providing accounts as part of the package, and electronically delivering the closed account to a financial institution which is providing accounts as part of the package.

25. An apparatus comprising:
means for electronically negotiating in real time between a first party and a second party to attain a negotiated agreement for a package of financial accounts to meet financial needs of the first party; and
means for automatically fulfilling the negotiated agreement by electronically closing an account of the first party which relates to the package and which preexists at a financial institution not providing accounts as part of the package, and for electronically delivering the closed account to a financial institution which is providing accounts as part of the package.
